(19) United States
(12) Patent Application Publication
(10) Pub. No.: US 2010/0307790 A1
(43) Pub. Date: Dec. 9, 2010

(54) TWINAX CABLE

(75) Inventor: Satoshi OKANO, Tochigi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 12/796,439

(22) Filed: Jun. 8, 2010

(30) Foreign Application Priority Data
Jun. 8, 2009 (JP) P.2009-137013

(51) Int. Cl. H01B 7/00

(52) U.S. Cl. 174/113 C

(57) ABSTRACT

A twinax cable includes at least a pair of core wires, each of which includes a conductor and an insulator covering an outer periphery of the conductor. The insulator includes an inner insulator covering the outer periphery of the conductor and an outer insulator covering an outer periphery of the inner insulator. The inner insulator is formed by a non-colored compressed insulator. The outer insulator is formed by a colored compressed insulator. A thickness of the outer insulator is formed thinner than a thickness of the inner insulator. The outer insulators of the pair of core wires are formed to have hues that are set respectively differently.

### TECHNICAL FIELD

The present disclosure relates to a twinax cable that is housed in a HDMI (High-Definition Multimedia Interface) cable used in communicating the video and sound signals, or the like and is used in a differential signaling system.

### RELATED ART

The low voltage differential signaling (LVDS) system is known as the system that transmits digital signals by employing the twinax cable that uses a pair of insulated signal conductors. In this signaling system, for example, on the transmitter side, signals whose phases are inverted by 180 degree respectively are input simultaneously into a pair of signal conductors and transmitted, and on the receiver side, the transmitted signals are differentially synthesized so that the signal output can be doubled. This signaling system is equipped with a function of eliminating the noises. More specifically, the noise signals that are produced in the course of the transmission line, which extends from the transmitter side to the receiver side, are applied equally to the pair of signal conductors, so that the noise signals are canceled mutually when these signals are output as the differential signals on the receiver side.

In the twinax cable, the pair of insulating wires have the same hue and it is difficult to discriminate the signal lines, and the like.

On the contrary, JP-A-2002-358841 discloses a cable 1′ as shown in FIG.5B, which includes a pair of insulating wires 2, drain wires 6 arranged on both sides of the pair of insulating wires 2, an outer conductor 7 formed by winding a metallic foil tape on an outer side of the drain wires 6, and a jacket 8 covering an outer side of the outer conductor 7. The insulating wire 2 is formed into the same shape as that in FIG. 5A, and includes a conductor 3 and a two-layered insulator consisting of an inner layer 4 made of a porous fluorine resin and an outer layer 5 formed of a skin layer made of a substantial fluorine resin. Respective hues of skin layers 5a, 5b of the outer layers 5 of the pair of insulating wires 2 can be made to be different. According to such configuration, the porous inner layer 4 that is ready to be crushed can be protected by the skin layer of the outer layer, and a degradation of a relative permittivity and a characteristic impedance can be reduced.

However, the foamed insulator of the inner layer as the main insulator is vulnerable to elongation and tensile strength. In particular, like the above JP-A-2002-358841, when the twinax cable with the drain wire is bent, this cable is easily crushed and it is feared that the electrical insulating property is lowered.

In order to render the hue of the insulator different for the purpose of discriminating the signal lines, the coloring pigment must be added to the insulating resin. However, the permittivity is increased by adding the coloring agent (pigment) and the permittivity is different depending on a color of the added coloring agent. Therefore, the permittivity may become different according to a combination of colors of the paired insulating wires, and thus the propagation time of the signal may be largely different.

### SUMMARY

Exemplary embodiments of the present invention provide a twinax cable that is excellent in the mechanical properties such as bending, tension, etc., is capable of discriminating respective cables based on a hue of an insulator, and is capable of reducing a time difference in propagation of the signal between the conductors.

A twinax cable according to an exemplary embodiment of the present invention, includes: at least a pair of core wires, each of core wires including a conductor and an insulator covering an outer periphery of the conductor, wherein the insulator includes an inner insulator covering the outer periphery of the conductor and an outer insulator covering an outer periphery of the inner insulator, and wherein the inner insulator is formed by a non-colored compressed insulator, and the outer insulator is formed by a colored compressed insulator. A thickness of the outer insulator may be formed thinner than a thickness of the inner insulator. The outer insulators of the pair of core wires may be formed to have hues that are set respectively differently.

According to the twinax cable of the exemplary embodiment of the present invention, both the inner insulator and the outer insulator of the insulator are formed of the compressed insulator. Therefore, the mechanical strength of the cable can be enhanced, and thus the crush due to the external force, etc. can be prevented, and a reduction of the electrical characteristics can be reduced. Since a coloring agent is added only to the outer insulator, an increase of the permittivity can be reduced, and a time difference (skew) of the propagation of the signal between the conductors can be reduced to the lowest minimum.

### BRIEF DESCRIPTION OF THE DRAWINGS

FIGS. 1A to 1C are views showing twinax cables according to various embodiments of the present invention.

FIG. 2A is a view showing an example of a communication cable in which a plurality of twinax cables as shown in FIG. 1A are assembled.

FIG. 2B is a view showing an example of a communication cable in which a plurality of twinax cables as shown in FIG. 1 B are assembled.

FIG. 3 is a view showing a change of permittivity difference due to a thickness of an outer insulator.

FIG. 4 is a view showing verified results of a skew improvement according to the present invention.

FIGS. 5A and 5B are views explaining the related-art cables.

### DETAILED DESCRIPTION

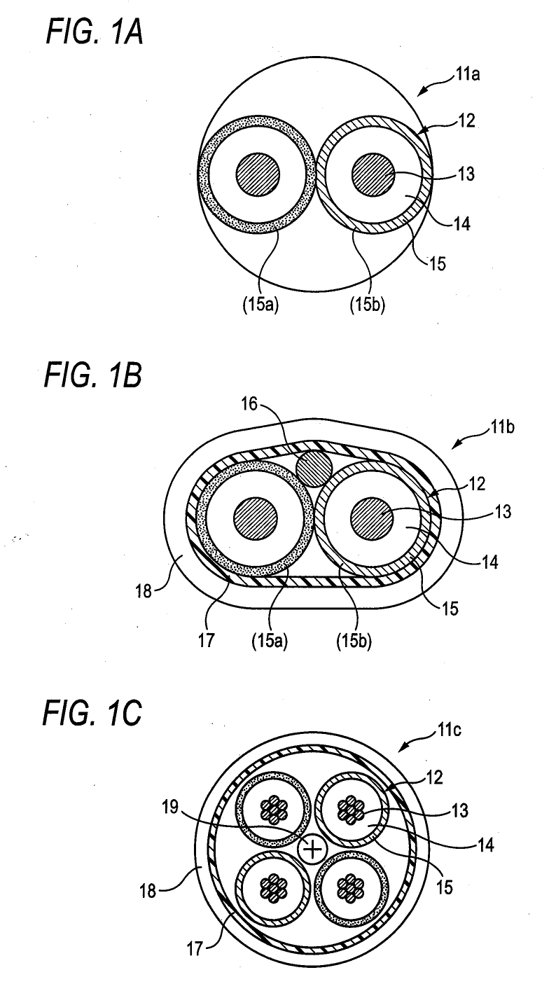

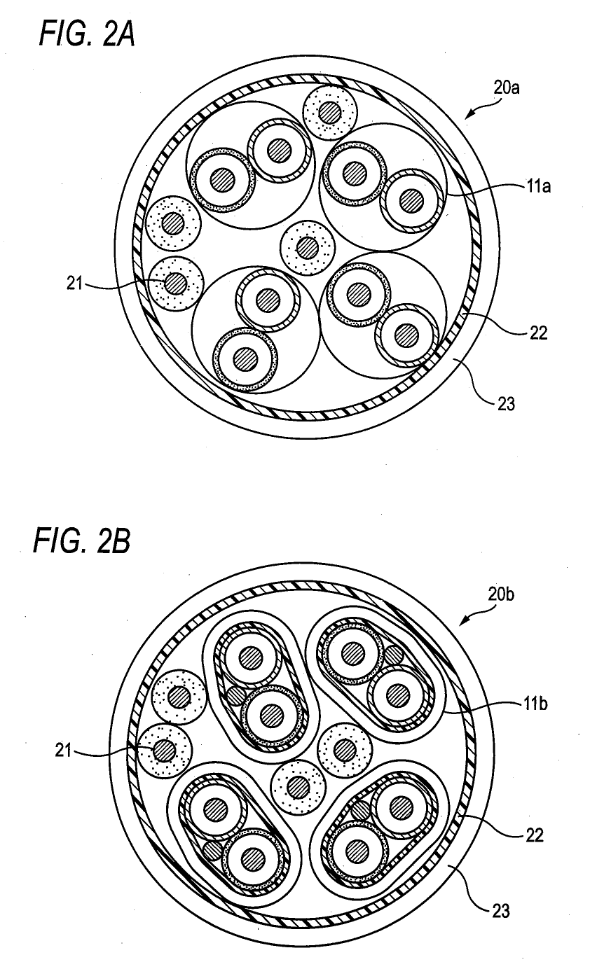

Exemplary embodiments of the present invention will be explained with reference to the drawings hereinafter. FIGS. 1A to 1C are views explaining twinax cables according to various embodiments of the present invention, and FIG. 2A and 2B are views showing examples of communication cables in which a plurality of twinax cables are assembled, respectively. In FIG. 1 and FIG. 2, 11a to 11b denote a twinax cable respectively, 11c denotes a quad cable,12 denotes a core wire, 13 denotes a conductor, 14 denotes an inner insulator, 15 denotes an outer insulator, 15a and 15b denote a hue respectively, 16 denotes a drain wire, 17 denotes a shield conductor, 18 denotes a jacket, 19 denotes a filler, 20a and 20b denote a communication cable respectively, 21 denotes an other wire, 22 denotes a common shield conductor, and 23 denotes a cable sheath.

The twinax cable according to the present invention can be applied to both a mode (twisted pair) in which two insulated wires whose conductors are insulated with the insulator respectively (referred to as the “core wires” hereinafter) are twisted together and a mode in which two insulated wires are not twisted but aligned in parallel. Any of the insulated wire to which the shield conductor is provided and the insulated wire to which the shield conductor is not provided may be employed. Two pairs of four-twisted wire (quad wire) may be employed. The communication cable in which a plurality of the twinax cables are assembled and are covered with the common sheath to fit in with various applications may be employed. Further, as occasion demands, the cable whose whole structure is shielded by the common shield conductor may be employed.

FIG. 1A is a view showing the twinax cable 11a in which a pair of core wires 12 are twisted together and a shield conductor is not provided. The core wire 12 is formed by covering the conductor 13 with a two-layered insulator that consists of the inner insulator 14 and the outer insulator 15. The twisted pair cable is constructed by twisting two core wires 12 together.

The conductor 13 is formed by a single core wire or a twisted wire in which the good electric conductor made of copper, aluminum, or the like is employed or the tin plating, or the like is applied to such good electric conductor. For example, the conductor whose outer diameter is about 0.12 to 0.3 mm is employed.

As the inner insulator 14 for insulating electrically the conductor 13, the insulator whose permittivity is set as small as possible is employed. For example, polyethylene (PE), ethylene-vinylacetate copolymer (EVA), fluorine resin, or the like may be employed. In the present invention, the inner insulator 14 is formed not by the foamed insulator but by the compressed insulator, and is formed on the outer periphery of the conductor 13 by means of the extrusion molding. The inner insulator 14 is still kept in an original color of a non-colored resin in which the coloring agent such as the coloring pigment, or the like is not added.

The outer insulator 15 may be formed of the same resin as the inner insulator 14. Alternately, the resin whose abrasion resistance is larger than the inner insulator, e.g., a polyurethane resin, or the like may be employed. The coloring agent such as the coloring pigment, or the like is added to the outer insulator 15, and then the outer insulator 15 is formed on the outer periphery of the inner insulator 14 as the compressed insulator by means of the simultaneous molding or the tandem molding. As the coloring pigment added to the outer insulator 15, various coloring pigments such as white, red, blue, green, etc. can be employed as described later. The hues 15a, 15b of the outer insulators 15 of the paired core wires 12 can be set respectively differently.

A total insulator thickness of the inner insulator 14 and the outer insulator 15 is set to about 0.25 mm, a diameter of the conductor is set to 0.3 mm, and an outer diameter of the core wire 12 is set to about 0.8 mm, for example. In this case, a thickness of the outer insulators 15 is set thinner than a thickness of the inner insulator 14, for example, a thickness Ta of the inner insulator 14 is set to 0.21 mm and a thickness Tb of the outer insulators 15 is set to 0.04 mm. That is, it is desirable that a thickness of the outer insulators 15 should be set to 0.15 mm or less and also Tb/Ta≦0.2 should be satisfied.

FIG. 1B is a view showing the twinax cable 11b in which a cable having a pair of core wires 12 that are arranged in parallel is shielded by the shield conductor 17. As explained in FIG. 1A, the core wire 12 is formed by covering the conductor 13 with the two-layered insulator consisting of the inner insulator 14 and the outer insulator 15. A pair of core wires 12 can be paired while setting the hues 15a, 15b of the outer insulator 15 respectively differently.

This twinax cable 11b is made by arranging a pair of core wires 12 in parallel without twist, putting longitudinally the drain wire 16 along the portion at which both core wires 12 contact mutually, and wrapping longitudinally or winding spirally the metallic foil tape used for the shield conductor 17, or the like to bundle the above members together as the cable. In this case, as the metallic foil tape constituting the shield conductor 17, the tape formed by laminating the metallic foil made of aluminum, copper, or the like on the plastic base material such as polyethylene terephthalate (PET), or the like is employed.

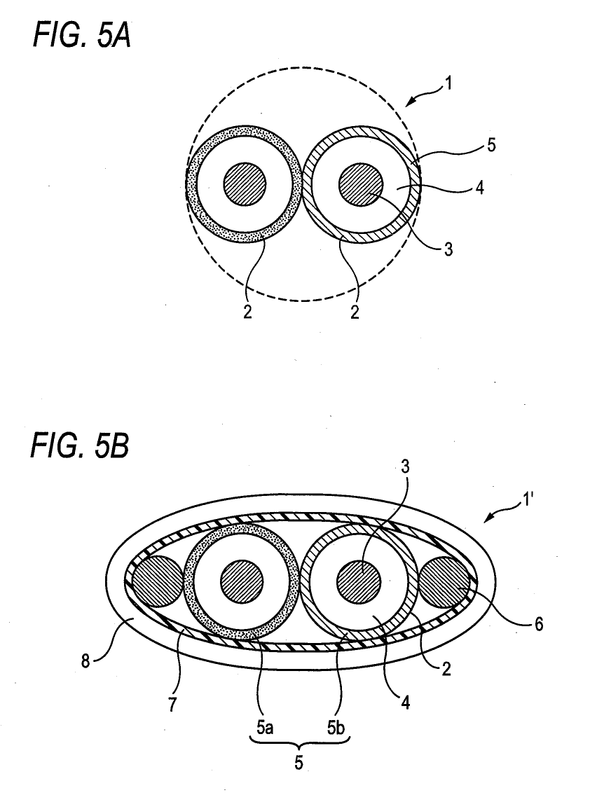

In FIG. 1B, an example in which the drain wire 16 is arranged only on one side of the portions at which both core wires 12 contact mutually is illustrated. In this case, another drain wire 16 may be arranged on the opposite side of the portions. Also, as shown in FIG. 5B, the drain wire 16 may be arranged on both sides of a pair of core wires 12, instead of the portions at which both core wires 12 contact mutually.

In this case, the jacket 18 may be provided on the outer periphery of the shield conductor 17. The jacket 18 may be formed a thermoplastic resin such as polyethylene, poly(vinyl chloride), fluorine resin, or the like by means of the extrusion molding, or may be formed by winding the resin tape.

FIG. 1C is a view showing the quad cable 11c in which two-paired (four) core wires 12 are arranged in parallel or a twisted fashion and the whole structure is shielded by the shield conductor 17. As explained in FIG. 1A, the core wire 12 is formed by covering the conductor 13 with the two-layered insulator consisting of the inner insulator 14 and the outer insulator 15. The core wires 12 can be discriminated by the color while setting the hues respectively differently. Like FIG. 1B, two pairs of core wires 12 are bundled together as the shield cable by wrapping longitudinally or winding spirally the metallic foil tape used for the shield conductor 17, or the like. Although omitted in FIG. 1C, the quad cable 11c may be connected to GND by using the drain wire. The filler 19 positioned at the center of the cable is provided not to collapse the combination of the core wires.

FIG. 2A shows an example of the communication cable in which a plurality of twinax cables 11a of the above twisted pair are assembled. In addition to the twinax cables, other wires 21 may also assembled. FIG. 2B shows an example of the communication cable in which a plurality of twinax cables 11b having the above two cores being aligned in parallel are assembled. In addition to the twinax cables, other wires 21 may also assembled, like FIG. 2A. A plurality of twinax cables 11a, 11b are shielded totally by the common shield conductor 22, and also the overall structure is protected with the cable sheath 23.

The permittivity of the resin material, which is used in the insulator of the above core wire 12, is measured after various coloring agents (pigments) are added to the resin material and resulting resin material is shaped into a sheet of 1 mm thickness. The irradiated cross-linked polyethylene whose permittivity is relatively small is employed as the resin material, then the coloring agents showing various hues are added to the resin materials respectively, then the resultant resin materials are shaped into a sheet respectively, and then the permittivity of the sheet is measured. In case the coloring agent is “white”, the sheet has a relatively large permittivity (2.42). In contrast, in case the coloring agent is other colors “green, red, blue, . . . , gray” respectively, the permittivity is slightly varied but the permittivity is within a range (2.32 to 2.36).

Here, a signal propagation velocity (V) and a signal delay time (Td) acting as the causes of skew generation are expressed by

V=C/√ε (C: light velocity, s: permittivity)

Td=L/V=k√ε (L: cable length).

In the differential signaling system using the two-core twinax cable, a difference (skew) of the signal delay time (Td) between the paired conductors must be reduced as small as possible. For this purpose, it is desirable that either the permittivity ε of the combined core wires should be made equal or a difference should be minimized.

It is desirable that, since the permittivity is different based on the hue, the twinax cable should be constructed by the core wires having the same hue. It is possible to say that, for example, the case where “white” is employed as the hue of one insulator whereas “other color” is employed as the hue of the other insulator is not preferable. However, in some cases the insulator of the core wire cannot but have a predetermined hue depending on the user's demand, or the like.

In the present invention, as described above, the insulator of the core wire constituting the twinax cable is formed by two layers (inner insulator and outer insulator) that are formed of the compressed insulator, the coloring agent is not added to the inner insulator, and the coloring agent is added only to the outer insulator to give the hue. Therefore, it is only the outer insulator that causes a difference in the permittivity. In this case, a difference in the permittivity between the insulators of the core wires including the inner insulator and the outer insulator can be made small by thinning a thickness of the outer insulator.

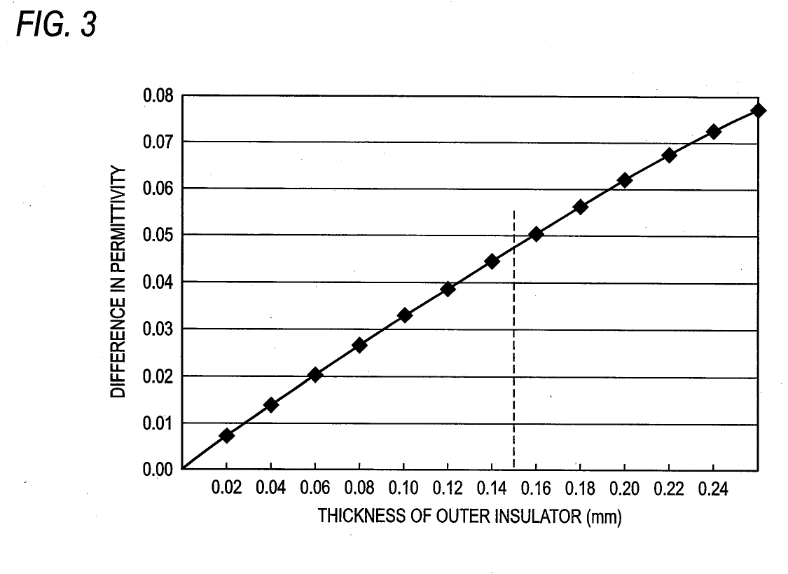

FIG. 3 shows the verified results of the relationship between a thickness of the outer insulator and a difference in the permittivity between the pair of core wires under the conditions that the conductor of the core wire has an outer diameter 0.3 mm (equivalent to AWG 30 by seven twisted conductors each having an outer diameter 0.1 mm), the irradiated cross-linked polyethylene whose outer diameter is 0.8 mm and whose total thickness is 0.25 mm is employed as the insulator, and the hue of the outer insulator of one core wire is set to “white” whereas the hue of the outer insulator of the other core wire is set to “blue”. In this case, in order to satisfy the skew of 25 ps/m or less, a difference in the permittivity between the pair of core wires (a difference in the permittivity of the insulators of the paired core wires) must be set to 0.05 or less. For this purpose, a thickness of the outer insulator may be set to 0.15 mm or less (a thickness of the inner insulator may be set to 0.1 mm or more). Here, it is preferable that, in view of a variation of the insulator, a thickness of the outer insulator should be set thinner than the inner insulator.

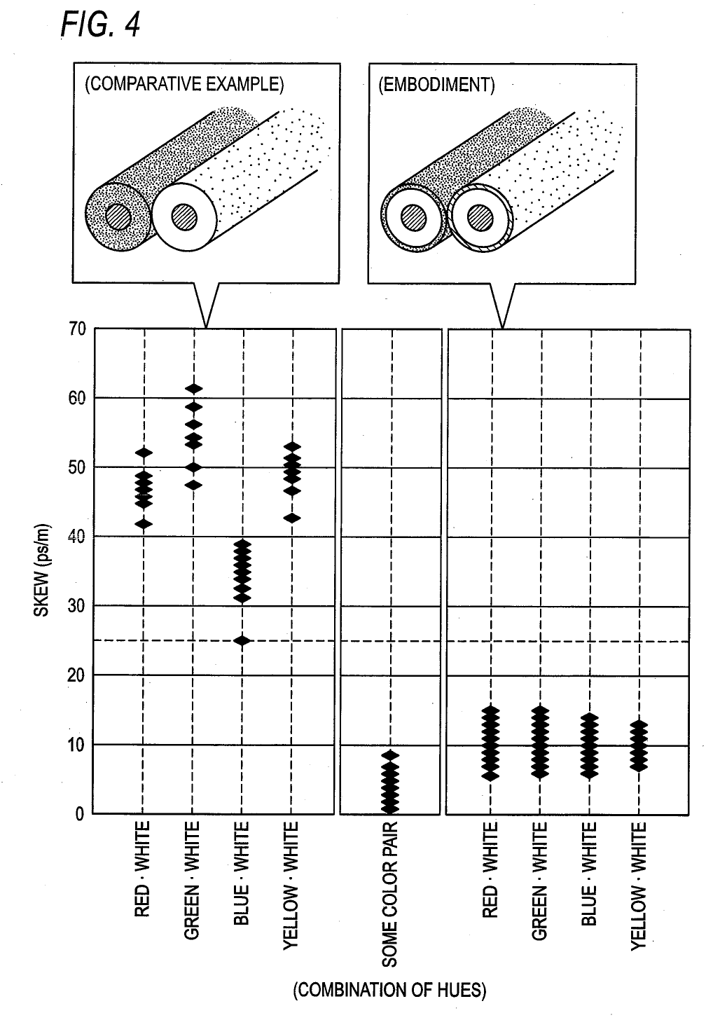

FIG. 4 is a view showing verified results of a skew of the twinax cable according to the present invention. As the comparative example, such a twinax cable is constructed that the two-layered structure is not employed as the insulator of the core wire (thickness 0.25 mm), the coloring agent is added uniformly into the whole insulator, and a combination of the hues “white” and other colors “red, green, blue, yellow”, which has a largest difference in the permittivity, is employed as a combination of the hues. In this case, although there is a variation in the combination of the hues, an average of the skews between the paired conductors is 45.1 ps/m.

In contrast, in the present invention, the twinax cable (embodiment) is constructed such that the insulator of the core wire is separated into two layers (inner insulator and outer insulator), the coloring agent is added only to the outer insulator (thickness 0.04 mm), and the hue combination similar to the comparative example is used. In this case, a variation in the hue combination is small, and an average of skews between the paired conductors is 10.9 ps/m that falls below a request value (25 ps/m or less). Here, when the core wires having the same hues are employed in the twinax cable, a skew between the paired conductors is below 10 ps/m.

As described above, when the insulator of the core wire is separated into two layers (inner insulator and outer insulator) and also the coloring agent is added only to the outer insulator, a difference in the permittivity between the core wires that are combined together as the twinax cable can be made small. As a result, a skew between the conductors in the twinax cable can be reduced small, and discriminablility can be provided to the core wires by adding different hue to the core wires respectively. Both the inner insulator and the outer insulator are formed of the compressed insulator. As a result, the insulator never suffers damage by the bending or the external force, and the stable signaling characteristic can be provided to the twinax cable.

In this case, when the similar twinax cable manufactured by using the core wires that are formed by foaming the insulator is bent, sometimes the foamed insulator is broken and a short circuit is caused between the drain wire and the conductor.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A twinax cable comprising:
at least a pair of core wires, each of core wires including a conductor and an insulator covering an outer periphery of the conductor,
wherein the insulator includes an inner insulator covering the outer periphery of the conductor and an outer insulator covering an outer periphery of the inner insulator, and
wherein the inner insulator is formed by a non-colored compressed insulator, and the outer insulator is formed by a colored compressed insulator.

2. A twinax cable according to claim 1, wherein a thickness of the outer insulator is formed thinner than a thickness of the inner insulator.

3. A twinax cable according to claim 1, wherein the outer insulators of the pair of core wires are formed to have hues that are set respectively differently.

4. A twinax cable according to claim 2, wherein the outer insulators of the pair of core wires are formed to have hues that are set respectively differently.
